(19) United States
(12) Patent Application Publication
(10) Pub. No.: US 2012/0246995 A1
(43) Pub. Date: Oct. 4, 2012

(54) RETRACTABLE KNIFE SPEAR

(76) Inventor: Richard C. Moore, JR., Charleston, SC (US)

(21) Appl. No.: 13/436,232

(22) Filed: Mar. 30, 2012

Related U.S. Application Data
(60) Provisional application No. 61/470,150, filed on Mar. 31, 2011.

(51) Int. Cl. A01K 81/06; A01K 81/04

(52) U.S. Cl. 43/6

(57) ABSTRACT

A retractable compact knife spear is provided. The knife spear may include a knife blade, as opposed to standard barbs and may be compacted to strap to a diver's leg. The retractable knife spear may include other features, such as sound signaling devices and may be used as a pointer when leading dive teams. The retractable knife spear is useful for eradication of invasive fish species, such as the lion fish in the Caribbean and along the U.S. east coast.

### CROSS-REFERENCE TO RELATED APPLICATIONS

This utility patent application claims benefit of U.S. Provisional Application Ser. No. 61/470,150, filed Mar. 31, 2011, which is incorporated herein by reference thereto.

### BACKGROUND OF THE DISCLOSURE

Spear fishing has been part of the SCUBA and skin diving industry for many years. Conventional spear guns and fiberglass and aluminum pole spears abound. A popular variation of the common pole spear is the “Hawaiian Sling.” Additionally, several varieties of multiple-piece travel spears are available in the market.

Known spear guns and pole spears range in length from two to six feet. Due to their length, when not in use, typical pole spears, for instance, are not easily stored, and existing spear guns and pole spears can be difficult to manage on board a vessel and under water. Such large unwieldy equipment typically limits a diver to a single spear gun or pole. Moreover, the average diver must carry other tools besides the spear gun or pole spear, such as a knife and a signaling device.

In addition to the various conventional spear guns and pole spears, numerous tips for pole spears, such as barbed tridents and unitary spear tips (with a barb) are available in the marketplace.

What is needed in the fishing spear industry is a compact, multipurpose assembly with improved safety features, utility and durability that can also be used to combat an invasion of lion fish into the Caribbean and along the east coast of the United States.

### BRIEF SUMMARY OF THE DISCLOSURE

The present disclosure is directed, in general, to a retractable knife diving spear having various features, such as a sound signal device and a knife blade that may be retractable or foldable for safety. The retractable diving knife spear also can be used as a pointer when leading dive groups.

As described in detail below, the components of the disclosure are simple to manufacture and use.

A retractable knife spear according to the disclosure may be used to combat an invasion of lion fish into the Caribbean and east coast of the United States. Lion fish are an invasive species from the South Pacific with no natural predators. They multiply rapidly and divers have been asked to exterminate them. However, carrying a four to six foot dive spear on every dive is problematic and known pole spears have limited utility.

For example, in one embodiment according to the present disclosure, a compact knife spear includes a singular knife head, a compactable body and reflective and noise-making components. The knife can be sheathed so that the knife spear may be used as a pointer to lead dive groups to reduce any impact on sensitive aquatic environments.

In another embodiment, a dive tool according to the disclosure may include a body having a coupling and a first configuration in a first state and a second configuration in a second state, the coupling being configured to transform the body between the first configuration and the second configuration; a selector operatively disposed on the body; and a plurality of tools disposed in the body and selectable by the selector, at least one of the tools configured to spear fish.

In this embodiment the coupling may be a telescoping arrangement or a folding arrangement, such as a ratchet and pawl or a “pocket knife” folding arrangement.

The selector may be a push button or a slide.

The first configuration may fold or telescope into a smaller area or profile than the second configuration. This may be accomplished by a telescope drive, a pawl and a rachet, and the like.

The dive tool may include a noise maker such as a whistle, a reflective element knife, a barb, a projectile and a storage compartment.

Additional aspects of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of such variations upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a plan view of a retractable spear according to an aspect of the disclosure, particularly showing the spear in an extended state;

FIG. 2 is a plan view of the spear as in FIG. 1, particularly showing the spear in a retracted state according to an aspect of the disclosure;

FIG. 3 is a partial detailed view of a portion of the spear as in FIG. 1, particularly showing a knife blade in accordance with an additional aspect of the disclosure: and

FIG. 4 is a partial detailed view of a portion of the spear as in FIG. 1, particularly showing various features of the spear in accordance with another aspect of the disclosure.

### DETAILED DESCRIPTION OF THE DISCLOSURE

Detailed reference will now be made to the drawings in which examples embodying the present subject matter are shown. The detailed description uses numerical and letter designations to refer to features of the drawings. Like or similar designations of the drawings and description have been used to refer to like or similar parts of various exemplary embodiments.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed description are provided by way of explanation only and are not meant as limitations of the disclosure. The present subject matter thus includes any modifications and variations of the following examples as come within the scope of the appended claims and their equivalents.

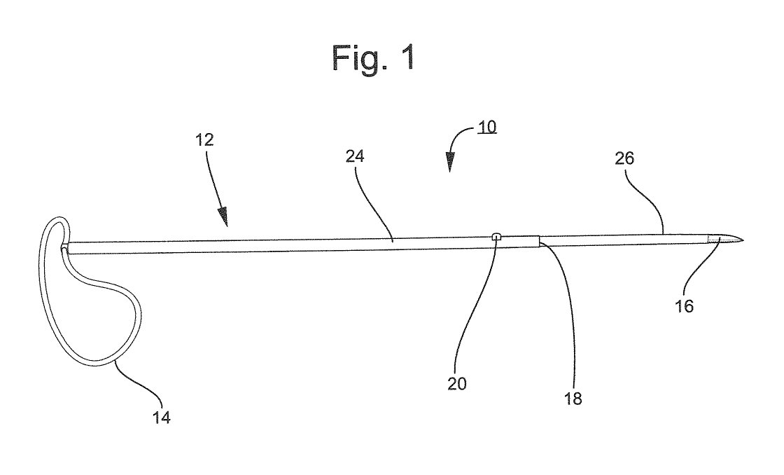

Turning now to FIG. 1, a retractable dive spear is designated in general by the element number 10. The exemplary dive spear 10 broadly includes a body 12, a handle 14, and a spear tip 16. In one embodiment, the body 12 may include a first section 24 that is about 2% feet in length and one (1) inch in outer diameter (“O.D.”), and a second section 26 may be about 2% feet long with a 0.875 inch O.D. inner shaft. As shown, the second section 26 is inserted within the first section 24 at area 18. In this example, the sections 24, 26 are retractable or collapsible together via a mechanical button 20. However, the arrangement could be a twist and groove locking device or other suitable adjusting mechanism.

The handle 14 shown in FIG. 1 may be a rubber sling used for propulsion. In use, when extended, the overall length of the spear 10 may be approximately five feet in one embodiment.

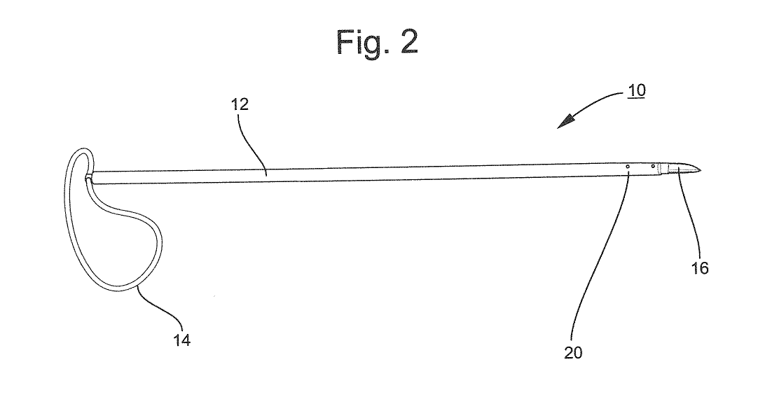

As shown in FIG. 2, when the button 20 is activated, the spear 10 retracts to approximately three (3) feet overall.

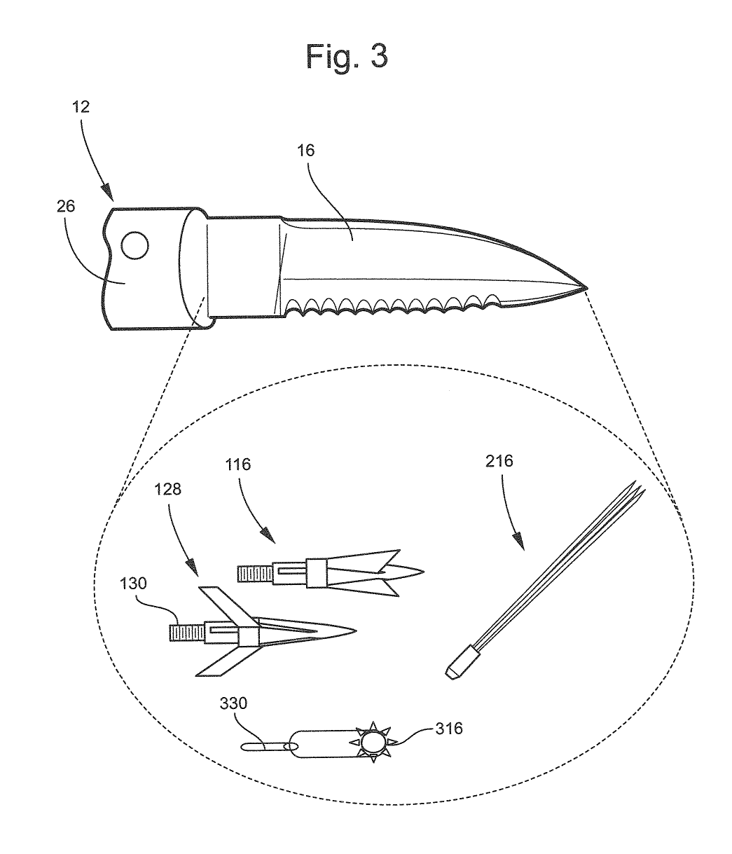

FIG. 3 most clearly shows that the spear tip 16 may be a three (3) inch stainless steel blade with a smooth edge on top and a serrated edge at the bottom. In this example, the spear tip 16 is a serrated steel blade, but it could be a smooth blade or serrated on either edge. The spear tip 16 may also be a hardened blade to counter the force exerted when spearing a fish. These impact forces may be repeated many times over the course of a dive and quickly render a standard blade unusable. The spear tip 16 is also replaceable. By way of further example, the knife tip 16 could be modified to include a barb to retain the fish when speared. For instance, as shown in the inset of FIG. 3, the spear tip may be a multiple blade device 116 having, in this example, four blades spaced about 90 degrees apart. As shown, the exemplary four blades of the multiple blade device 116 form a relatively thicker tip than one having fewer blades. Upon striking a lion fish, for example, the blades may spring open in arrangement 128 to barb or hook the fish. This arrangement provides for a relatively strong tip to better withstand “missed” shots that may occasionally strike hard surfaces such as rock or metal. Likewise, the relatively sturdy multiple blade device 116 may have a longer service life than less robust devices. The multiple blade device 116 may also utilize industry standard six (6) mm female threads 130 to facilitate replacement of the multiple blade device 116 and/or to utilize other tips 216 such as a TRIDENT BARB or a PARALYZER brand tip. Still other blade types may be used in addition to the examples described above. The tip could be a projectile or contact explosive 316 attachable to a body by threads 330. Such tips could be stored in a compartment such as compartment 234 described relative to FIG. 5 below.

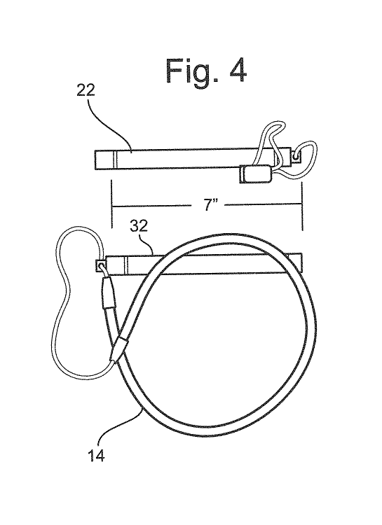

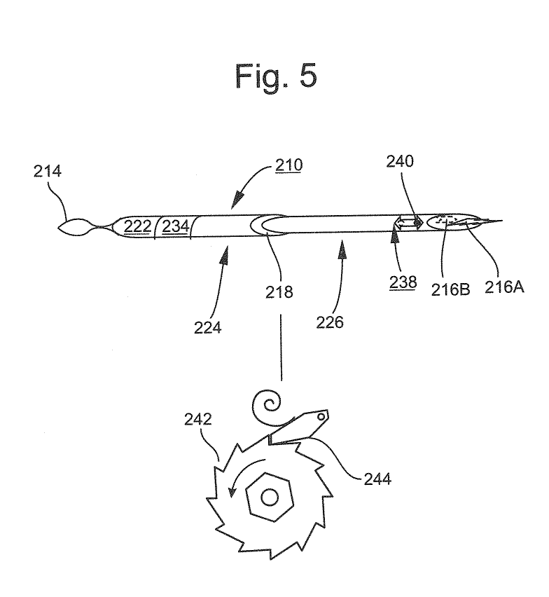

Turning to FIG. 4, the retractable knife spear 10 utilizes the rubber sling 14 for propulsion. Also shown, the dive spear 10 may include a sound signaling device 22. The sound signaling device 22 is used to gain attention of divers underwater and is normally attached to the diver using a lanyard. Replacing the conventional lanyard with the rubber sling 14 and then inserting the sound signaling device 22 into the knife spear 10 yields a dual purpose device. Finally, the sound signaling device 22 is wrapped with a U.S. Coast Guard approved “Solas” reflective strip 32 to enhance visibility for emergencies.

Two sound signaling devices that may be used for the sound signaling device 22 are an AQUACRAFT seven (7) inch aluminum device or an AQUA MARACA, which is approximately four inches in length utilizing a plastic shell. AQUACRAFT inserts two one-half inch stainless steel ball bearings inside an aluminum shell while the AQUA MARACA has three (3) three-eighths (⅜) inch stainless steel ball bearings. Lengths, widths and construction materials may vary between manufacturers and are not intended to limit the present disclosure.

A retractable knife spear 110 may be further reduced to an overall length of about twelve (12) inches to enable a diver to wear the device 110 on the diver's leg similar to a standard diving knife. The retractable spear 110 provides, for example, a three-in-one device, which can be used as a knife, a spear and a sound signaling device. When extended, a diver may also use the knife spear as a pointer to keep divers from making direct contact with sensitive aquatic life.

Another purpose for the retractable knife spear 110 is to combat the invasion of lion fish into the Caribbean and east coast of the United States. Lion fish are an invasive species from the South Pacific with no natural predators. These invasive fish multiply rapidly and recreational divers have been asked to exterminate them in certain geographic areas. The retractable knife spear 110 is much more convenient than carrying a typical four to six foot spear, which makes the request to help eradicate the lion fish more palatable and practical for recreational divers.

in FIG. 5, a foldable or compressible multi-tool 210 includes a combination carrier strap and sling 214, which may be used for propulsion, a sound signaling device 222, which may be an explosive device or whistle, and a storage compartment 234 for first aid supplies, wax pencils, extra tips and the like. In this embodiment, the sound signaling device 222 may be attached to or incorporated in a first section 224 of the tool 210 and wrapped with reflective tape to enhance visibility for emergencies. As further shown, a selector 238 may be incorporated in a second section 226 of the tool 210. Here, the selection apparatus 238 includes a spring loaded push-to-slide button 240. which selectively engages one of multiple tool heads, such as a barb 216A or a knife blade 216B. In this example, the button 240 is used to select and project one of the tools 216A, 216B from within the section 226. Those skilled in the art will appreciate that additional and different tools could be provided at section 226. Additionally, although telescoping arrangements are indicated in this example at area 218 (to insert or extract section 226 relative to section 224) and as provided by selection apparatus 238, the tool 210 and its components may be configured to be folded or opened like a pocket knife and is not limited to compression or telescoping arrangements. For instance, a rachet 242 and a pawl 244 may be used to fold section 224 and section 226 relative to each other.

While the present subject matter has been described in detail with respect to specific embodiments thereof, it will be appreciated that those skilled in the art, upon obtaining an understanding of the foregoing, may readily produce alterations to, variations of, and equivalents to such embodiments. Accordingly the scope of the present disclosure is by way of example rather than by way of limitation, and the subject disclosure does not preclude inclusion of such modifications, variations, and/or additions to the present subject matter as would be readily apparent to one of ordinary skill in the art.

That which is claimed is:

1. A dive tool, comprising:
a body having a coupling and a first configuration in a first state and a second configuration in a second state, the coupling being configured to transform the body between the first configuration and the second configuration;
a selector operatively disposed on the body; and
a plurality of tools disposed in the body and selectable by the selector, at least one of the tools configured to spear fish.

2. The dive tool as in claim 1, wherein the coupling is one of a telescoping arrangement and a folding arrangement.

3. The dive tool as in claim 1, wherein the selector is a push button.

4. The dive tool as in claim 1, wherein the selector is a sliding mechanism.

5. The dive tool as in claim 1, wherein the first configuration is smaller than the second configuration.

6. The dive tool as in claim 1, further comprising a noise maker.

7. The dive tool as in claim 1, further comprising a reflective element.

8. A dive tool, comprising:
a body having a coupling and a first configuration in a first state and a second configuration in a second state, the coupling being configured to transform the body between the first configuration and the second configuration;
means for changing the body between the first configuration and the second configuration; and
means for spearing fish.

9. The dive tool as in claim 8, wherein the means for changing the body is a telescope drive.

10. The dive tool as in claim 8, wherein the means for changing the body is a pawl and a rachet,

11. The dive tool as in claim 8, wherein the means for spearing fish is one of a knife, a barb and a projectile.
